(19) United States
(12) Patent Application Publication
(10) Pub. No.: US 2008/0047725 A1
(43) Pub. Date: Feb. 28, 2008

(54) EQUIPOTENTIAL GROUND SYSTEM AND METHOD OF CONSTRUCTING THE SAME

(75) Inventors: Young-ki Chung, Seoul (KR); Kang-su Lee, Incheon-si (KR)

Correspondence Address: HAMRE, SCHUMANN, MUELLER & LARSON, P.C., P.O. BOX 2902, MINNEAPOLIS, MN, 55402-0902, US

(73) Assignee: Young-ki Chung, Seoul (KR)

(21) Appl. No.: 11/616,193

(22) Filed: Dec. 26, 2006

(30) Foreign Application Priority Data
Jul. 13, 2006 (KR) 10-2006-0065719

(51) Int. Cl. H01R 4/66; H02G 13/00

(52) U.S. Cl. 174/2; 174/6

(57) ABSTRACT

Provided are an equipotential ground system and a method of constructing the same capable of equalizing potential of all positions when the ground system is configured in a mesh manner.

The equipotential ground system includes: a mesh having a plurality of row lines, and a plurality of column lines installed to cross the row lines to form intersection parts electrically connected to the row and column lines; first ground rods connected to corners of the mesh; and a plurality of second ground rods having a larger ground resistance than the first ground rods and connected to the outermost intersection parts of the mesh, which are disposed between the first ground rods.

### BACKGROUND OF THE INVENTION

1. Field of the Invention

The present invention relates to an equipotential ground system and a method of constructing the same, and more particularly, to an equipotential ground system and a method of constructing the same capable of equalizing potential of all positions when the ground system is configured in a mesh manner.

2. Description of the Prior Art

Generally, a ground electrode means a terminal for electrically connecting various electric, electronic, and communication equipment to the earth. A contact resistance, i.e., an electrical resistance, generated between the ground electrode and the earth is a ground resistance.

Therefore, when leakage current or noise current is generated, potential is raised due to the ground resistance of the ground electrode, thereby causing various problems in a system.

Ideally, the ground resistance is zero Ω, however this is impossible in reality. Therefore, it is necessary to constitute a ground system that avoids problems in grounded equipment.

Meanwhile, a mesh or grid ground related to the present invention, which is set up to cover a large area of earth having high resistivity, such as a building zone, is formed of a copper wire and buried underground in a mesh structure.

Since the mesh ground can readily obtain a low ground resistance, a low touch potential, and a low step potential, it primarily employed where safety is a high priority. However, it requires a large area, is difficult to construct and is costly in comparison with other conventional ground methods. Also, since the mesh ground is impossible to perform maintenance on, it should be constructed perfectly from the start.

Such a mesh ground is required in power plants, substations, etc., and is also widely used in large plants and factories.

As shown in FIG. 1, the mesh-type ground system has a net structure. That is, bare copper wires are installed to form a mesh 10 having rows C and columns B at predetermined intervals.

The bare copper wire has a cross-sectional area of 100 mm²˜200 mm². The bare copper wires are electrically connected at connection points (hereinafter, referred to as “intersecting points”) by a crimp sleeve or heat generating welding. External ground wires may be extracted and used at various locations.

However, in the mesh-type ground system, when abnormal current such as lightening current is introduced into a central part of the mesh 10 as shown in FIG. 2, the current is concentrated at each corner of the ground system up to three times more than at the other parts, thereby making it impossible to perform equipotential grounding.

In addition, as shown in FIG. 3, when lightening current is introduced to one side of the mesh 10, it is also impossible to perform equipotential grounding due to deviation of the current passing through the earth.

That is, when a large amount of current is discharged through the earth, on the condition that the copper wires have the same or similar ground resistance, increased potential at a corresponding position may cause potential deviation throughout the entire ground area.

In order to solve the equipotential problem of the conventional mesh-type ground system, a mesh is horizontally installed as shown in FIG. 4A to constitute rows and columns at predetermined intervals. The rows and columns have the same size (same length, thickness, and so on) and thus provide the same ground resistance. Then, ground rods (vertically disposed as shown in FIG. 4A) are connected to the intersecting parts of the rows and columns of the mesh and buried in the earth.

FIGS. 4B, 4C, and 4D show profiles of a touch potential, a step potential, and an absolute potential, respectively, of the conventional mesh-type ground system.

As shown in FIGS. 4B, 4C, and 4D, indicating characteristics of potentials of the mesh-type ground system shown in FIG. 4A, the mesh is constituted of rows and columns at predetermined intervals, and the ground rods having the same size as the mesh are connected to the outermost intersection parts of the rows and columns of the mesh, thereby completing the ground system. In this case, since the amount of current discharged to the earth through the ground rods connected to the outermost intersection parts is remarkably larger than the amount of current discharged through other parts, the potential deviation is large.

As a result, failure of the mesh-type ground system to provide equipotential grounding may result in noise or surges in the event of lightening, electromagnetic interference (EMI), and so on, which can damage electronic appliances and/or cause them to malfunction.

### SUMMARY OF THE INVENTION

An object of the present invention is to provide an equipotential ground system and a method of constructing the same, capable of equalizing potential of a mesh-type ground system to prevent malfunction and damage of electronic appliances due to a ground potential difference.

An aspect of the invention provides an equipotential ground system including: a mesh having a plurality of row lines, and a plurality of column lines installed to cross the row lines to form intersection parts electrically connected to the row and column lines; first ground rods connected to corners of the mesh; and a plurality of second ground rods having a larger ground resistance than the first ground rods and connected to the outermost intersection parts of the mesh, which are disposed between the first ground rods.

Another aspect of the invention provides an equipotential ground system including: a mesh having a plurality of row lines, and a plurality of column lines installed to cross the row lines to form intersection parts electrically connected to the row and column lines; and fourth ground rods connected to the outermost intersection parts of the mesh, wherein the row and column lines of the mesh have smaller intervals at edges than a central part thereof.

Yet another aspect of the invention provides an equipotential ground construction method of installing a mesh having a plurality of conductors, and connecting a ground rod to each part of the installed mesh, characterized in that first ground rods grounded to each corner of the mesh have a ground resistance smaller than second ground rods grounded to the other parts except the corners of the mesh.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view for explaining a mesh-type ground system;

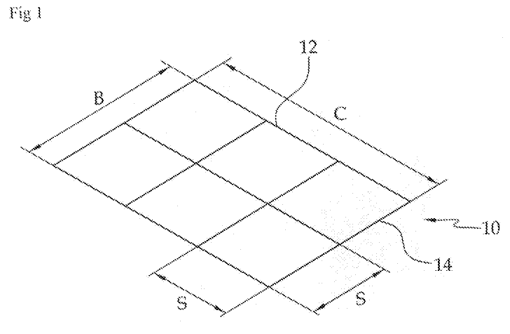

FIG. 2 is a perspective view showing a current distribution when lightening current is applied to the center of a mesh-type ground system;

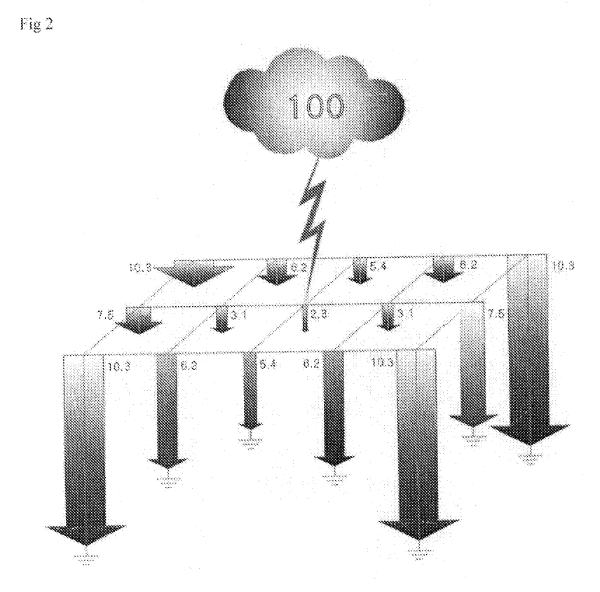

FIG. 3 is a perspective view showing a current distribution when lightening current is applied to one side of a mesh-type ground system;

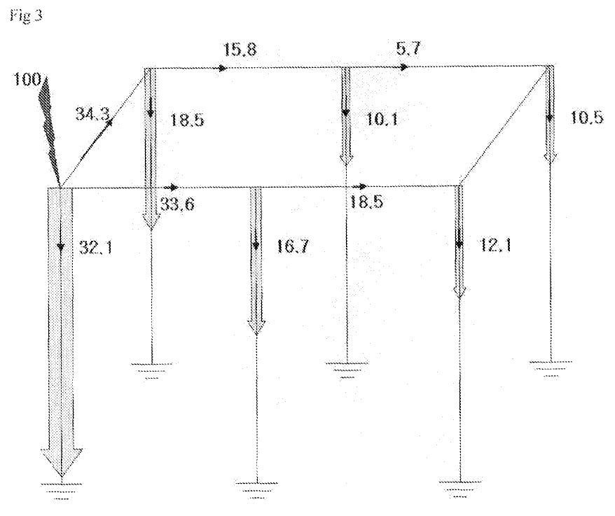

FIG. 4A is a schematic view of a conventional mesh-type ground system;

FIG. 4B shows a touch potential profile of the conventional mesh-type ground system;

FIG. 4C shows a step potential profile of the conventional mesh-type ground system;

FIG. 4D shows an absolute potential profile of the conventional mesh-type ground system;

FIG. 5A is a schematic view of a first embodiment in accordance with the present invention;

FIG. 5B is a plan view of the first embodiment in accordance with the present invention;

FIG. 5C is a front view of the first embodiment in accordance with the present invention;

FIG. 5D is a side view of the first embodiment in accordance with the present invention;

FIG. 5E shows a touch potential profile of the first embodiment in accordance with the present invention;

FIG. 5F shows a step potential profile of the first embodiment in accordance with the present invention;

FIG. 5G shows an absolute potential profile of the first embodiment in accordance with the present invention;

FIG. 6A is a schematic view of a second embodiment in accordance with the present invention;

FIG. 6B is a plan view of the second embodiment in accordance with the present invention;

FIG. 6C is a front view of the second embodiment in accordance with the present invention;

FIG. 6D is a side view of the second embodiment in accordance with the present invention;

FIG. 6E shows a touch potential profile of the second embodiment in accordance with the present invention;

FIG. 6F shows a step potential profile of the second embodiment in accordance with the present invention; and

FIG. 6G shows an absolute potential profile of the second embodiment in accordance with the present invention.

### DETAILED DESCRIPTION OF EXEMPLARY EMBODIMENTS

Hereinafter, exemplary embodiments of the present invention will be described with reference to the accompanying drawings.

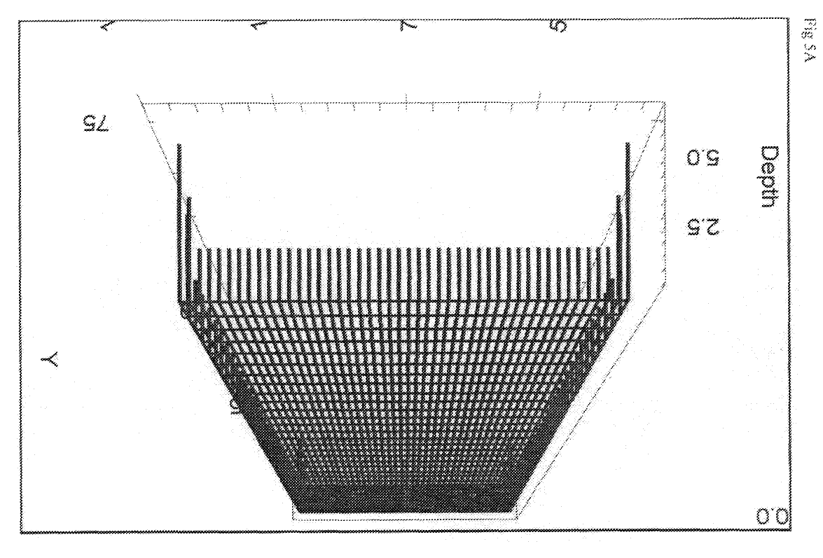

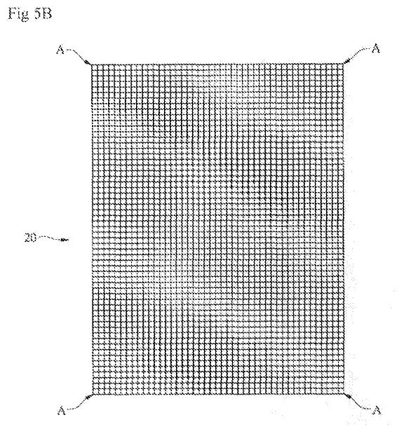

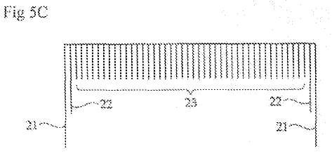

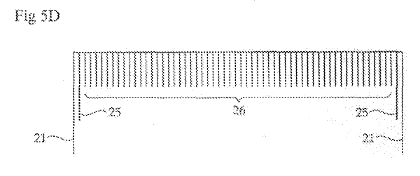

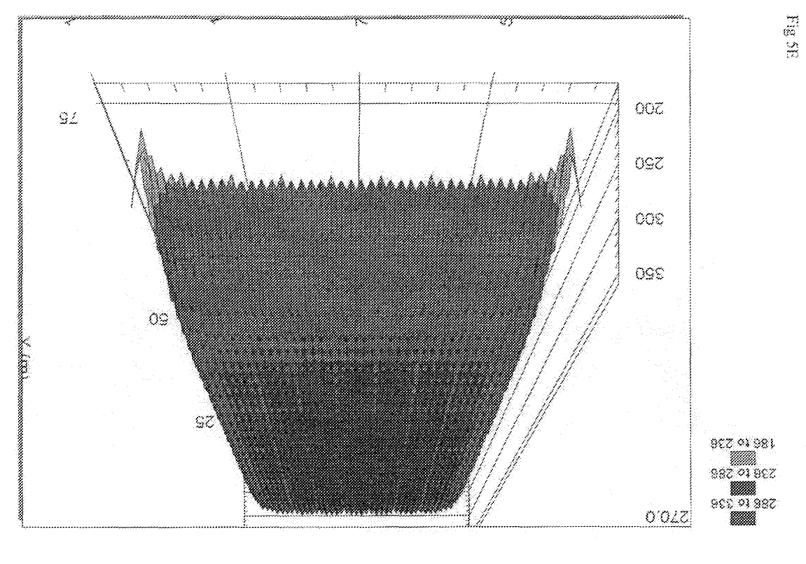

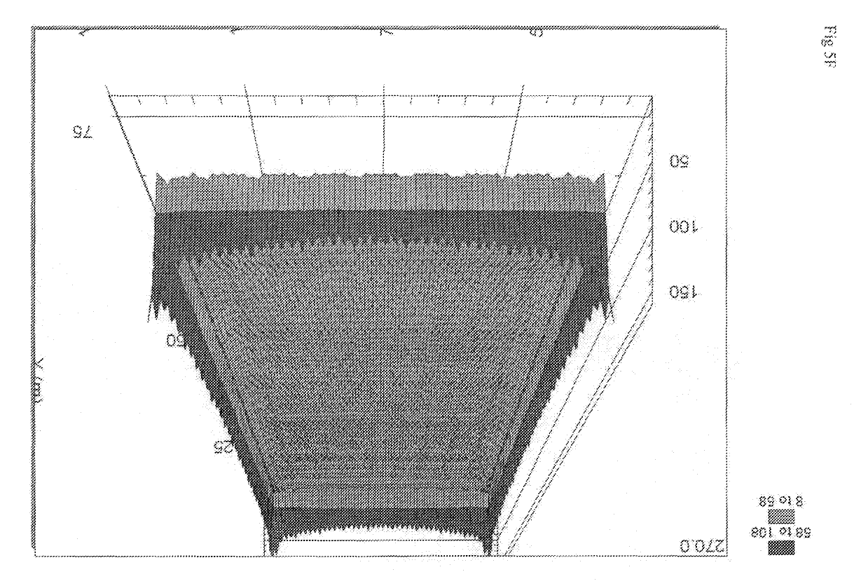

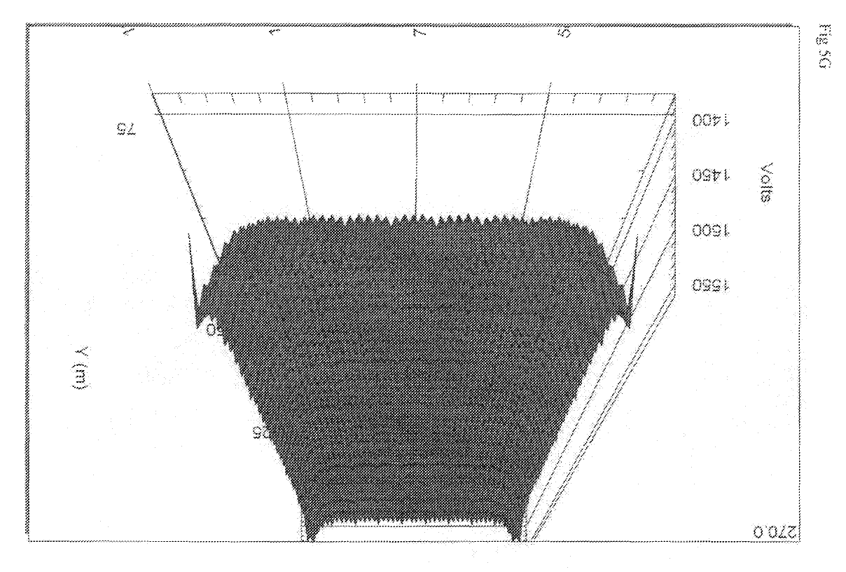

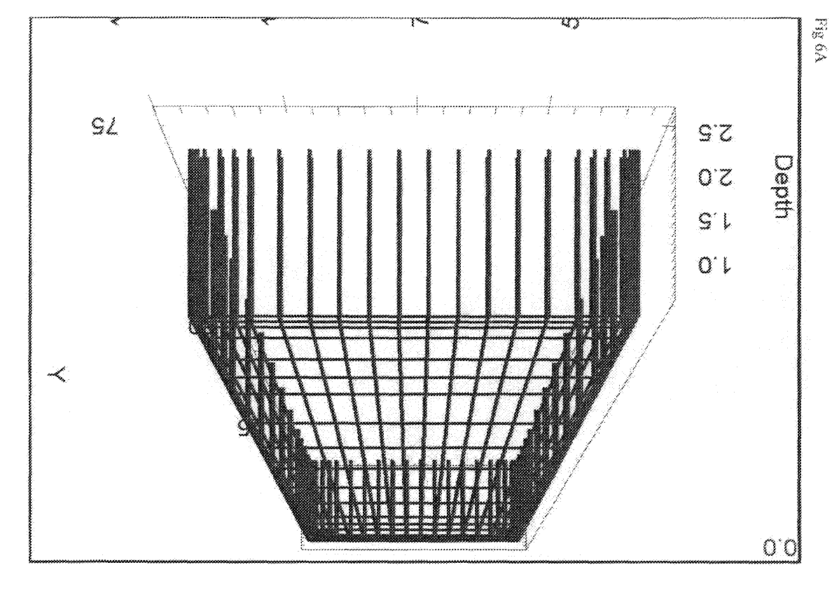

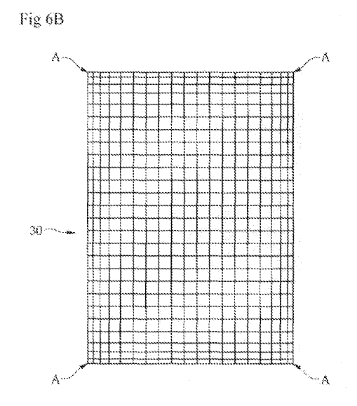

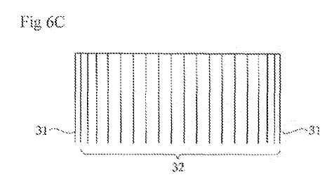

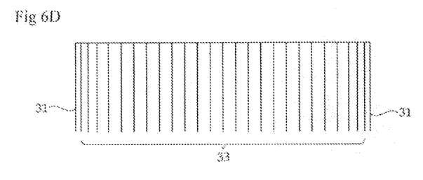

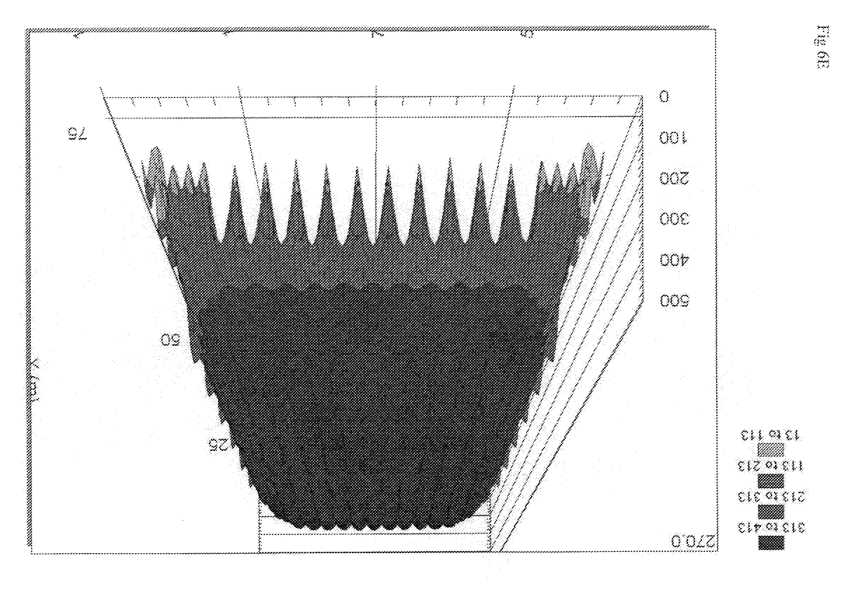

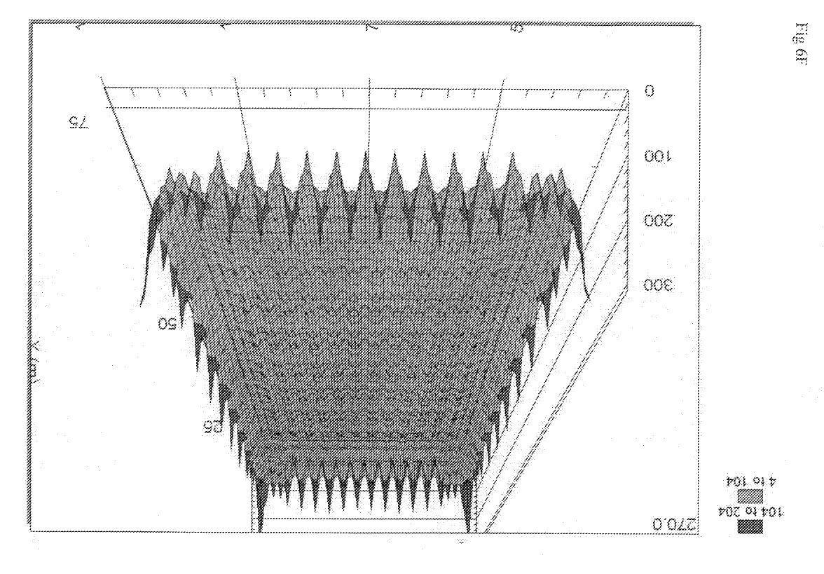

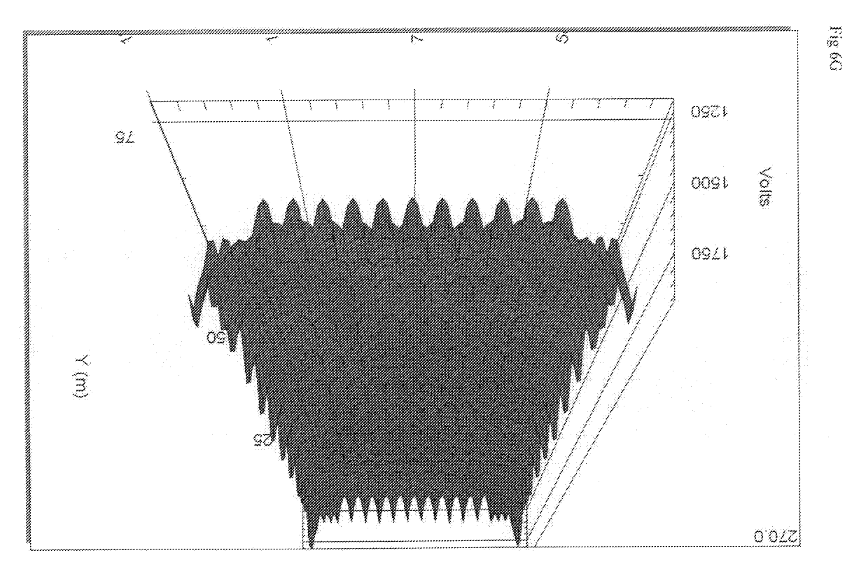

FIG. 5A is a schematic view of a first embodiment in accordance with the present invention, FIG. 5B is a plan view of the first embodiment in accordance with the present invention, FIG. 5C is a front view of the first embodiment in accordance with the present invention, FIG. 5D is a side view of the first embodiment in accordance with the present invention, FIG. 5E shows a touch potential profile of the first embodiment in accordance with the present invention, FIG. 5F shows a step potential profile of the first embodiment in accordance with the present invention, and FIG. 5G shows an absolute potential profile of the first embodiment in accordance with the present invention. FIG. 6A is a schematic view of a second embodiment in accordance with the present invention, FIG. 6B is a plan view of the second embodiment in accordance with the present invention, FIG. 6C is a front view of the second embodiment in accordance with the present invention, FIG. 6D is a side view of the second embodiment in accordance with the present invention, FIG. 6E shows a touch potential profile of the second embodiment in accordance with the present invention, FIG. 6F shows a step potential profile of the second embodiment in accordance with the present invention, and FIG. 6G shows an absolute potential profile of the second embodiment in accordance with the present invention.

A ground system in accordance with the present invention is provided to equalize a potential distribution of a mesh.

For this purpose, the potential deviation should be minimized by reducing ground resistance of an edge part relative to a central part of the mesh or distributing current passing through one ground rod.

Several embodiments of the present invention will now be provided to minimize the ground potential deviation.

### 1. First Embodiment

As shown in FIG. 5A to 5G, a mesh 20 has row lines and column lines disposed at predetermined intervals. First ground rods 21 having the smallest ground resistance are connected to corners of the mesh 20 (“A” of FIG. 5B), second ground rods 22 and 25 having a ground resistance larger than the first ground rods 21 are connected to an inner part adjacent to the first ground rods 21, and third ground rods 23 and 26 having a ground resistance larger than the second ground rods 22 and 25 are connected to an inner part between the second ground rods 22 and 25.

Therefore, the ground resistance becomes smaller in order of the third ground rods 23 and 26, the second ground rods 22 and 25, and the first ground rods 21.

As shown in FIG. 5B, referring to the mesh of the first embodiment of the present invention, the mesh 20 has row and column lines disposed at predetermined intervals.

In addition, the first ground rods 21, the second ground rods 22 and 25, and the third ground rods 23 and 26 are connected to outermost parts of the mesh 20 to be buried in the earth.

Since the first ground rods 21, the second ground rods 22 and 25, and the third ground rods 23 and 26 have different ground resistances, the mesh 20 has a larger ground resistance at edges than a central part thereof, and the smallest ground resistance at corners thereof.

In order to differentiate the ground resistances, the ground system of the first embodiment of the present invention has different lengths of ground rods, using the same material and thickness, thereby burying the ground rods to different depths in the earth.

That is, the third ground rods 23 and 26 are formed to a length such that a minimum ground resistance required in the ground system is provided. Then, the second ground rods 22 and 25 and the first ground rods 21 are sequentially formed to lengths in which the ground resistances become gradually smaller.

Since the mesh 20 in accordance with the first embodiment of the present invention has the largest ground resistance at the center, a middle ground resistance at edges, and the smallest ground resistance at corners, as shown in FIGS. 5E to 5G, it is possible to minimize a potential difference due to deviation of introduced current, thereby performing equipotential grounding.

In other words, when the current introduced to the corners of the mesh 20 is three times larger than the other parts, the first ground rods 21 should be three times longer than the third ground rods 23 and 26, and the second ground rods 22 and 25 should be twice longer than the third ground rods 23 and 26.

### 2. Second Embodiment

As shown in FIGS. 6A to 6G, a mesh 30 in accordance with a second embodiment of the present invention has row lines and column lines disposed at intervals which are larger at the center thereof and smaller at edges thereof.

That is, as shown in FIG. 6B, the mesh 30 has a large interval at the center thereof and a small interval at the edges thereof.

In addition, as shown in FIGS. 6C and 6D, ground rods 31, 32 and 33 connected to the mesh 30 have the same size (the same ground resistance), and are connected to corners (“A” of FIG. 6B) and the intersection parts of the row and column lines.

Therefore, the intervals of the ground rods 31, 32 and 33 get smaller from the center to edges thereof, similar to the mesh 30.

Unlike the first embodiment, in the mesh 30 in accordance with the second embodiment of the present invention, since the ground rods having the same ground resistance are more buried at the edges than at the center thereof, current density introduced into the earth through the ground rods is lowered to minimize a potential difference between the edges and the center, thereby equalizing the potentials as shown in FIGS. 6E to 6G.

### 3. Third Embodiment

A third embodiment of the present invention employs a mesh (not shown) having different intervals similar to the second embodiment, and ground rods having different ground resistances similar to the first embodiment.

Since the third embodiment of the present invention uses a mesh having different intervals and ground rods having different ground resistances, it is possible to precisely perform the equipotential grounding.

### 4. Ground Rod

The present invention uses low-resistance carbon ground rods. Since the low resistance carbon ground rods can readily obtain a low ground resistance and a low natural resistance to rapidly discharge current, it is possible to semipermanently use the ground rods without annual variation.

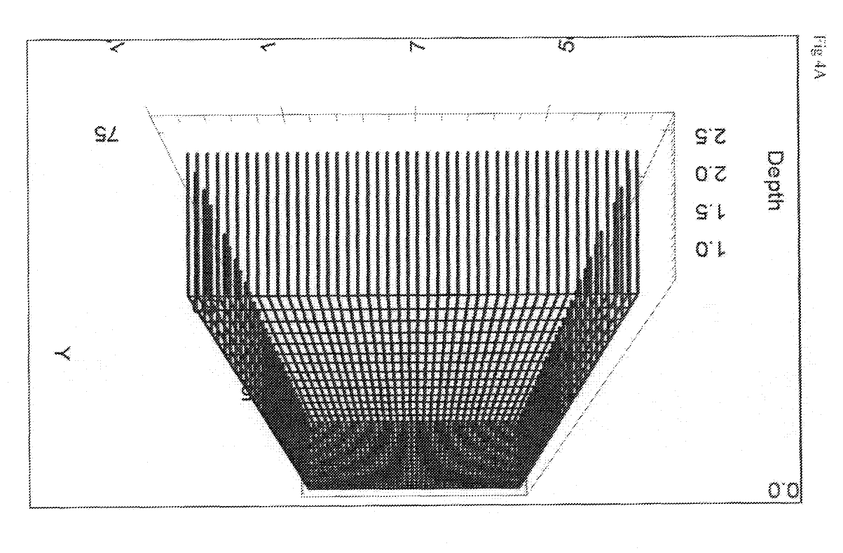

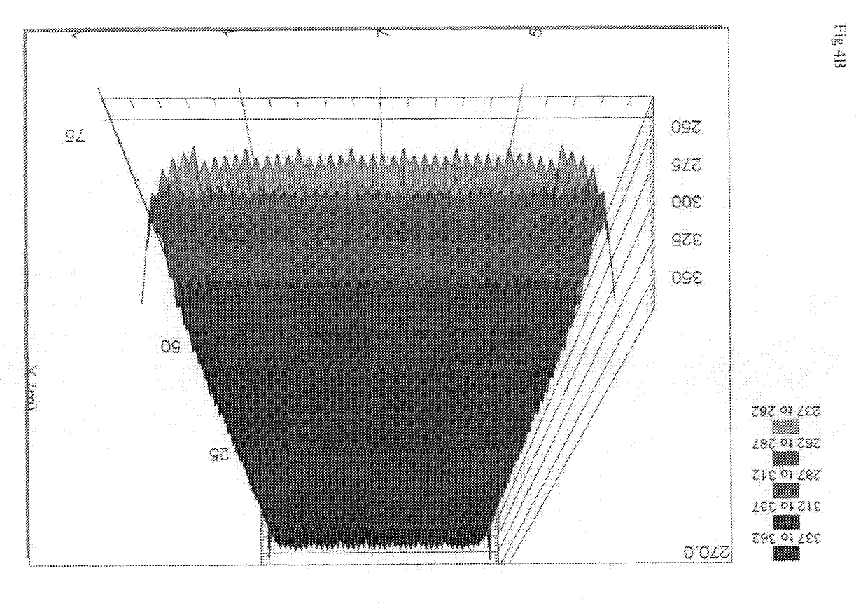

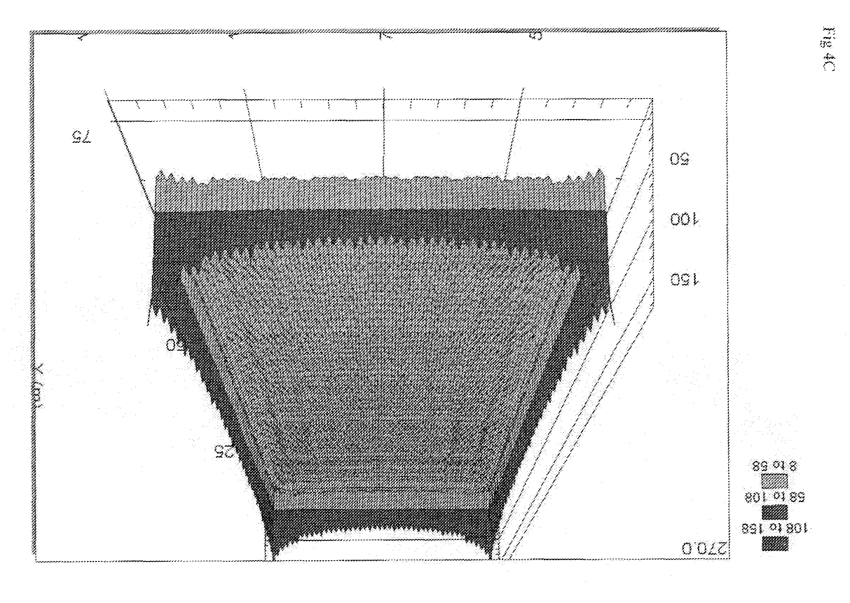

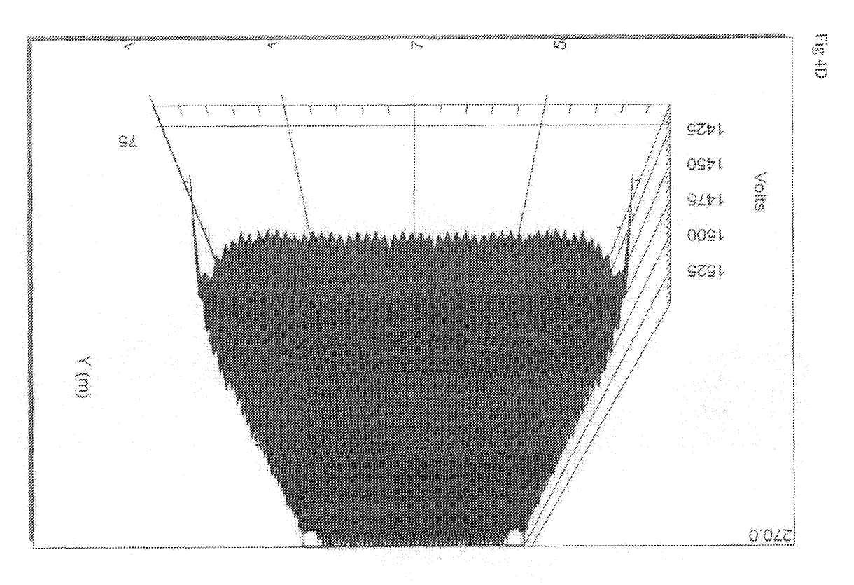

In addition, the low-resistance carbon ground rods used in the conventional art (FIG. 4A) and the embodiments of the present invention have a diameter of 260 mm and a length of 1,000 mm. But, the first embodiment of the present invention uses the first ground rods 21 having a length of 3,000 mm, the second ground rods 22 and 25 having a length of 2,000 mm, and the third ground rods 23 and 26 having a length of 1,000 mm.

### 5. Measurement Results

Measurement results of the first to third embodiments of the present invention and the conventional art will be described in the following Table 1

TABLE 1

| | | | | Cross- | Number | | | | | | |
|---|---|---|---|---|---|---|---|---|---|---|---|
| | Mesh | Mesh | Ground | sectional | of | Ground | | | | | |
| | area | interval | wire | area | Ground | resistance | GPR | Touch potential (V) | | Step potential (V) | |
| Classification | (m · m) | (m) | length | (mm²) | rods | (Ω) | (V) | Max | Measurement | Max | Measurement |
| Conventional | 90 · 60 | 2 | 5,500 | Bare | 150 | 1.42 | 1,779 | 758.9 | 364.5 | 2543.5 | 166.1 |
| art | | | | copper | | | | | | | |
| | | | | wire | | | | | | | |
| | | | | 120 | | | | | | | |
| First | 90 · 60 | 2 | 5,500 | Bare | 166 | 1.39 | 1,737 | 758.9 | 352.0 | 2543.5 | 152.9 |
| embodiment | | | | copper | | | | | | | |
| | | | | wire | | | | | | | |
| | | | | 120 | | | | | | | |
| Second | 90 · 60 | | 3,150 | Bare | 156 | 1.37 | 1,723 | 758.9 | 483.0 | 2543.5 | 296.7 |
| embodiment | | | | copper | | | | | | | |
| | | | | wire | | | | | | | |
| | | | | 120 | | | | | | | |
| Third | 90 · 60 | | 4,350 | Bare | 148 | 1.32 | 1,723 | 758.9 | 357.1 | 2543.5 | 223.8 |
| embodiment | | | | copper | | | | | | | |
| | | | | wire | | | | | | | |
| | | | | 120 | | | | | | | |

(Wherein, GPR: Ground potential rise)

As described in Table 1, the first embodiment employing ground rods having a length three times longer at corners and twice longer at positions adjacent to the corners than at the other parts had a safety potential lower than the conventional art (FIG. 4A). These results can also be seen from the profiles of the potentials of the embodiments.

In addition, the second embodiment and the third embodiment having different intervals in order to reduce the ground cost also represented low safety potentials in comparison with the conventional art.

Meanwhile, the potential profile results related to the conventional art and the first to third embodiments show the results under the condition, in addition to Table 1, that fault current introduced into the mesh is 5 kA, ground resistivities are 2,500 (Ω·m) in a depth of 0.5 m or less, 1,500 (Ω·m) in a depth of 0.5-1 m, and 200 (Ω·m) in a depth of 1.5 m or more, and fault tine of the introduced fault current is 0.5 seconds.

### 6. Construction Method

In order to construct a mesh-type ground system in accordance with the present invention, first, a mesh is installed on the ground using bare copper wires, and ground rods are connected to intersection parts of the mesh.

At this time, according to the construction methods, the mesh is installed to have the same interval (the first embodiment) or different intervals (the second and third embodiments), and then, the ground rods are buried and connected to the intersection parts of the edges and the corners of the mesh.

Of course, the ground rods may also be selected to have ground resistances appropriate to the embodiments.

As can be seen from the foregoing, a mesh-type ground system in accordance with the present invention is capable of minimizing ground potential deviation throughout the entire mesh area, thereby preventing malfunction and damage of electronic appliances.

In addition, it is possible to minimize the ground potential deviation to establish a novel concept of ground construction, thereby minimizing damage of a large electronic factory and a high-precision electronic factory due to lightening.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

What is claimed is:

1. An equipotential ground system comprising:
a mesh having a plurality of row lines, and a plurality of column lines installed to cross the row lines to form intersection parts electrically connected to the row and column lines;
first ground rods connected to corners of the mesh; and
a plurality of second ground rods having a larger ground resistance than the first ground rods and connected to the outermost intersection parts of the mesh, which are disposed between the first ground rods.

2. The equipotential ground system according to claim 1, wherein the first ground rods are longer than the second ground rods when the first and second ground rods have the same specific resistance material and cross-sectional shape.

3. The equipotential ground system according to claim 1, wherein the first or second ground rods are low-resistance carbon ground rods.

4. The equipotential ground system according to claim 2, wherein the first or second ground rods are low-resistance carbon ground rods.

5. The equipotential ground system according to claim 1, wherein the second ground rods are connected to positions adjacent to the first ground rods, and the system further comprises third ground rods having a ground resistance between the first and second ground rods.

6. An equipotential ground system comprising:
a mesh having a plurality of row lines, and a plurality of column lines installed to cross the row lines to form intersection parts electrically connected to the row and column lines; and
fourth ground rods connected to the outermost intersection parts of the mesh,
wherein the row and column lines of the mesh have smaller intervals at edges than a central part thereof.

7. The equipotential ground system according to claim 6, wherein the fourth ground rods have the same ground resistance.

8. The equipotential ground system according to claim 6, wherein the fourth ground rods are low-resistance carbon ground rods.

9. The equipotential ground system according to claim 7, wherein the fourth ground rods are low-resistance carbon ground rods.

10. The equipotential ground system according to claim 6, further comprising fifth ground rods connected to the intersection parts adjacent to the edges of the mesh and having a larger ground resistance than the fourth ground rods.

11. An equipotential ground construction method of installing a mesh having a plurality of conductors, and connecting a ground rod to each part of the installed mesh,
characterized in that first ground rods grounded to each corner of the mesh have a ground resistance smaller than second ground rods grounded to the other parts except the corners of the mesh.

12. The equipotential ground construction method according to claim 11, wherein the ground rods are low-resistance carbon ground rods.

13. The equipotential ground construction method according to claim 11, wherein the first ground rods are longer than the second ground rods when the first and second ground rods have the same specific resistance material and cross-sectional shape.

14. The equipotential ground construction method according to claim 11, wherein the mesh has intervals smaller at edges than a center part thereof.
